(19) United States
(12) Patent Application Publication
(10) Pub. No.: US 2016/0334972 A1
(43) Pub. Date: Nov. 17, 2016

(54) CONTENT OVERLAY FOR SOCIAL NETWORK POSTS

(71) Applicant: Yahoo!, Inc., Sunnyvale, CA (US)

(72) Inventors: Kevin Cheng, San Francisco, CA (US); Joel Kraut, San Francisco, CA (US); Jason LeBrun, San Francisco, CA (US)

(21) Appl. No.: 14/711,711

(22) Filed: May 13, 2015

(51) Int. Cl. G06F 3/0484; G06F 17/24; G06F 3/0482; G06F 3/0486; H04L 12/58; G06T 11/60

(52) U.S. Cl. CPC G06F 3/04845; H04L 51/32; G06T 11/60; G06F 3/0482; G06F 3/04842; G06F 3/0486; G06F 17/24

(57) ABSTRACT

Many users may share information, such as messages, photos, and/or links to websites or other content, through social networks as social network posts. As provided herein, a commentating user may be provided with the ability to overlay content, such as images, icons, text, links to websites, and/or other content visually and positionally onto a social network post to create an overlaid social network post. The commentating user may resize, reposition, and/or tag the content that is overlaid the social network post. In this way, various users may overlay content onto social network posts for an improved user interface and interaction for social network interfacing.

### BACKGROUND

Many users may share and interact with information through social networks. In an example, a user may post a birthday photo of a son's birthday party to a social network. In another example, the user may share a gardening article through a social network post. Social network posts, comprising photos, textual commentary, links, and videos, may be published to other social network users through social network newsfeeds. Many social networks provide limited interaction with a social network post, such as the ability to insert a textual comment, a link, and/or a sticker (e.g., a smiley face, a thumbs up, and/or other images, icons, etc.) in a separate comment section below the social network post and/or the ability to mark the social network post (e.g., like, favorite, heart, etc.). Unfortunately, other social network users may lack the ability to engage with social network posts in meaningful ways, such as visually and positionally adding content onto social network posts.

### SUMMARY

In accordance with the present disclosure, one or more systems and/or methods for overlaying content items onto social network posts are provided herein. A social network post, created by an originating user, may be displayed to a commentating user, such as through a social network feed (e.g., a vacation post of a vacation photo). User input, corresponding to a content overlay command associated with content, may be received from the commentating user. The user input may correspond to a position within the social network post (e.g., the user may drag and drop a smiley face sticker from a content selection interface onto a depiction of a boat within the vacation photo of the vacation post). The content, such as the smiley face sticker, may be overlaid onto the social network post at the position, such as over the depiction of the boat, to create an overlaid social network post. In this way, various users may positionally and visually add content onto the social network post, such as while the social network post is presented through social network newsfeeds. The overlaid social network post may be displayed to users through social network newsfeeds.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of overlaying content items onto social network posts.

FIG. 5A is a component block diagram illustrating an example system for overlaying content items onto social network posts, where a social network post is displayed to a commentating user.

FIG. 5B is a component block diagram illustrating an example system for overlaying content items onto social network posts, where a content selection interface and a create content interface are displayed to a commentating user.

FIG. 5C is a component block diagram illustrating an example system for overlaying content items onto social network posts, where a sticker is overlaid a social network post.

FIG. 5D is a component block diagram illustrating an example system for overlaying content items onto social network posts, where a sticker, overlaid a social network post, is resized.

FIG. 5E is a component block diagram illustrating an example system for overlaying content items onto social network posts, where a sticker, overlaid a social network post, is repositioned.

FIG. 5F is a component block diagram illustrating an example system for overlaying content items onto social network posts, where a thought bubble is overlaid a social network post.

FIG. 5G is a component block diagram illustrating an example system for overlaying content items onto social network posts, where a thought bubble, overlaid a social network post, is populated with text.

FIG. 5H is a component block diagram illustrating an example system for overlaying content items onto social network posts, where a link is overlaid a social network post.

FIG. 5I is a component block diagram illustrating an example system for overlaying content items onto social network posts, where overlay options are exposed to a commentating user.

FIG. 5J is a component block diagram illustrating an example system for overlaying content items onto social network posts, where an overlaid social network post is displayed to an originating user.

FIG. 5K is a component block diagram illustrating an example system for overlaying content items onto social network posts, where an overlaid social network post is displayed to a second user.

FIG. 6 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

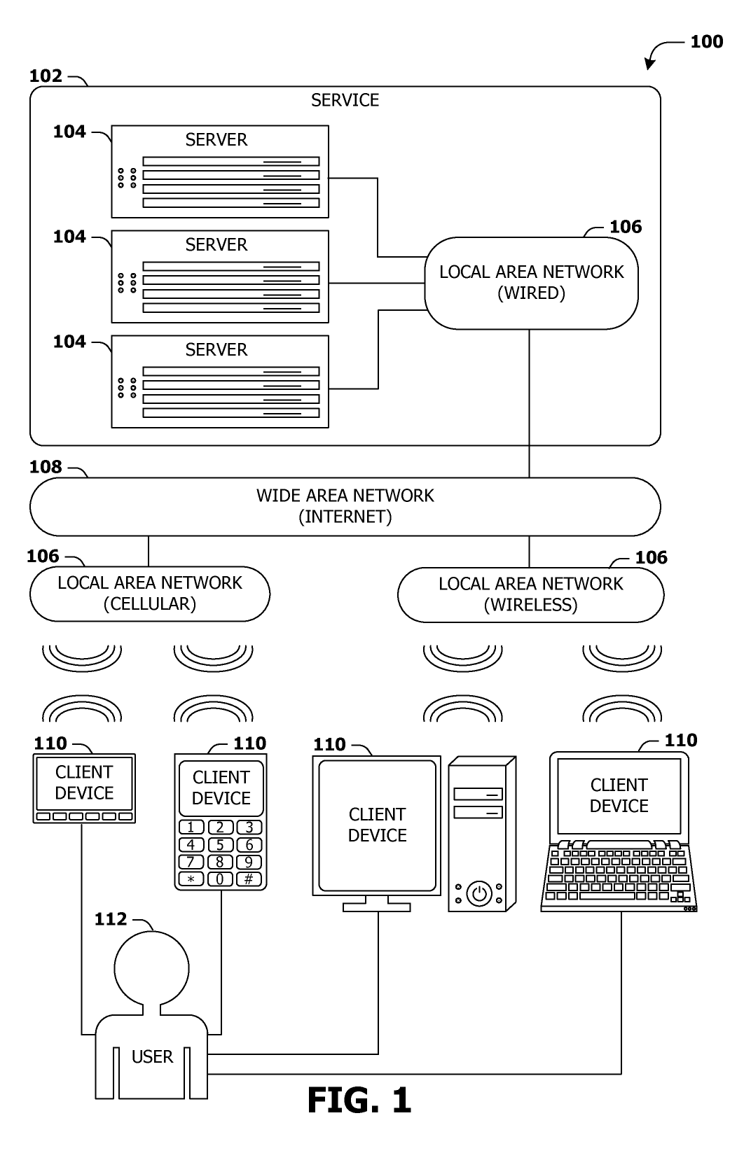

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

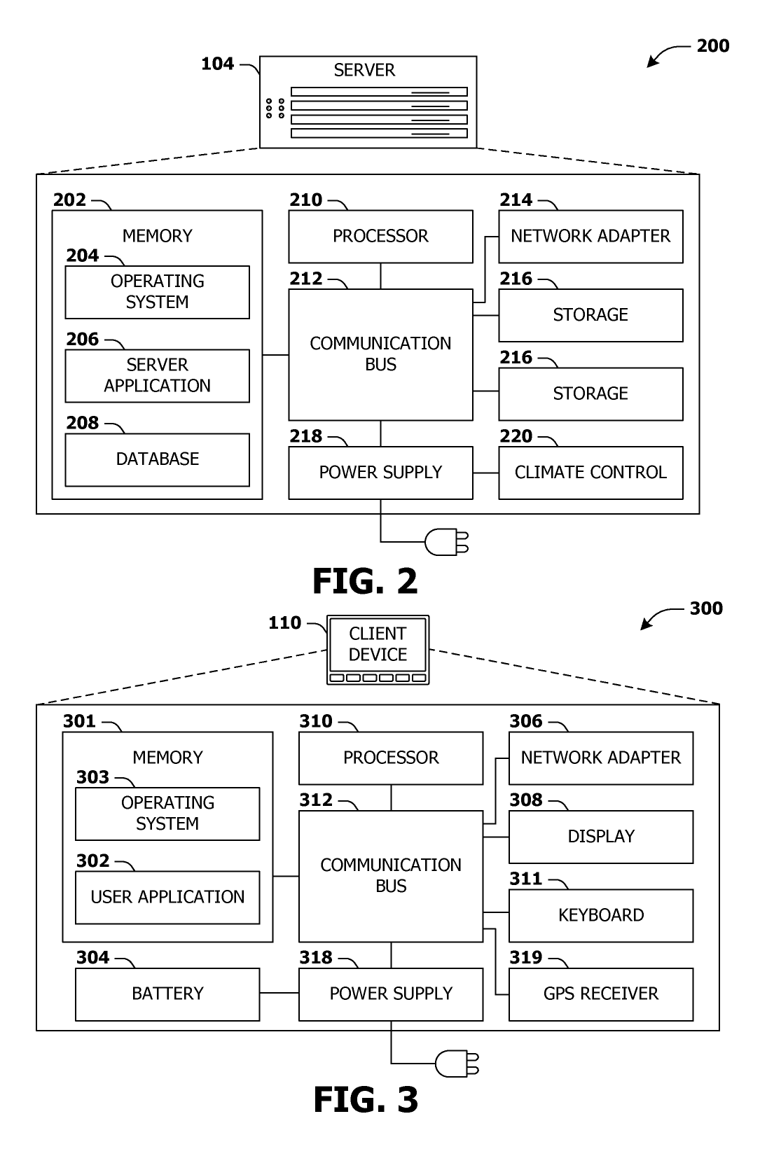

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, a cellphone or smartphone, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for overlaying content items onto social network posts are provided. Many users may share information, such as messages, photos, and/or links to websites or other content, through social networks as social network posts. Unfortunately, a user may have limited means for interacting with a social network post shared with the user. For example, the user may insert a textual comment, a link, and/or a sticker (e.g., a smiley face, a thumbs up, and/or other images, icons, etc.) in a separate comment section below the social network post and/or mark the social network post (e.g., like, favorite, heart, etc.). Unfortunately, the user may lack the ability to directly interact with and/or add content into the social network post. Accordingly, as provided herein, a commentating user may be provided with the ability to overlay content onto social network posts, such as by adding text, shapes, images, stickers, icons, links to external content, and/or a variety of other types of content directly onto social network posts (e.g., while a social network post, created by an originating user, displayed to the commentating user through a social network feed of the commentating user) to create overlaid social network posts. In this way, users may interact with social network posts in an efficient and new way (e.g., directly manipulating and expressing thoughts and ideas directly into and/or visually and positionally onto a social network post created by other users) for an improved user interface and interaction experience.

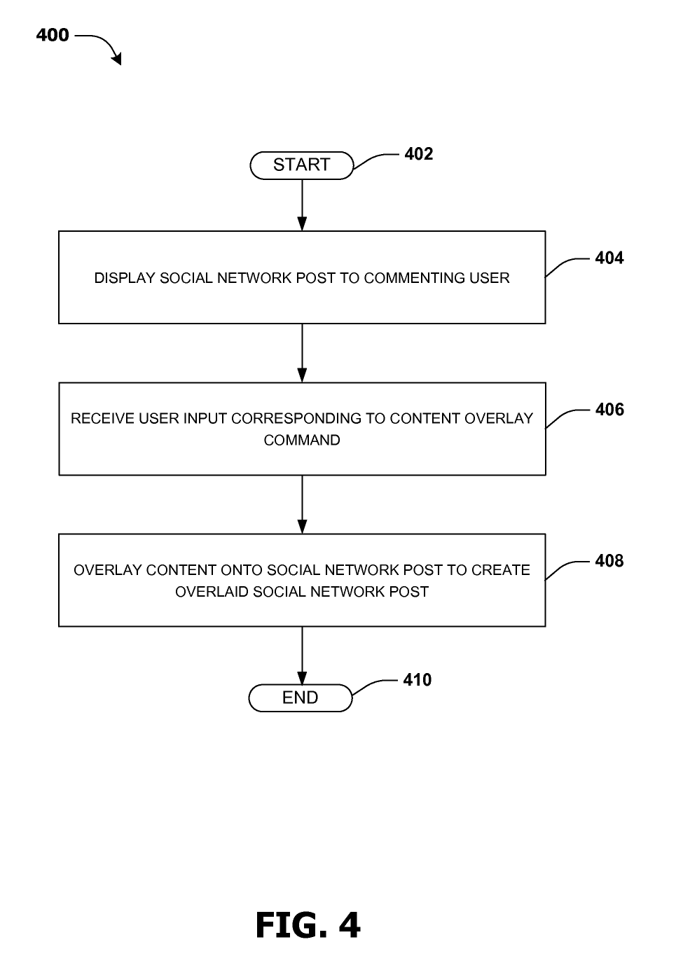

An embodiment of overlaying content items onto social network posts is illustrated by an example method 400 of FIG. 4. At 402, the method 400 starts. At 404, a social network post, created by an originating user, may be displayed to a commentating user. For example, Jill may create a fundraising social network post comprising a photo depicting Jill and a child bowling and a textual description “come support my fundraiser bowling team”, and thus Jill may be deemed as an originating user of the fundraising social network post. The fundraising social network post may be displayed on a social network newsfeed or through any other interface to Jack, and thus Jack may be deemed a commentating user that did not create the fundraising social network post but may, as provided herein, add content onto the fundraising social network post.

At 406, user input, from the commentating user, may be received at a position within the social network post. The user input may correspond to a content overlay command associated with content. In an example of receiving the user input, a create content interface may be exposed to the commentating user. User generated content may be received through the create content interface as the content. For example, the create content interface may allow Jack to draw directly onto the fundraising social network post, upload an image to place onto the fundraising social network post, input text to display on top of the fundraising social network post, etc. In another example of receiving the user input, a content selection interface, populated with a plurality of available content, may be exposed to the commentating user. A selection of available content, exposed through the plurality of available content, may be received as the content. The content may comprise an image, text (e.g., a defined phrase or text provided by the commentating user), a sticker (e.g., an icon), an animation, a user interface element (e.g., a text box, a button, a list box, etc.), a thought bubble (e.g., an interface into which the user may input text, such that the thought bubble may display the text with a user interacts such as hovers over with a cursor the thought bubble and/or may hide the text otherwise), a link (e.g., a link to a website, audio content, a video, execution of an application, a coupon, a location within a map interface, a document, task completion functionality, etc.), and/or any other type of content. In another example of receiving the user input, a text entry interface may be displayed to the commentating user based upon Jack selecting a thought bubble as the content. The thought bubble may be populated with text received from Jack through the text entry interface. In this way, Jack may select or provide content to overlay on top of the fundraiser social network post.

At 408, the content may be overlaid onto the social network post at the position to create an overlaid social network post. For example, Jack may have dragged and dropped a thumbs up sticker from the content selection interface onto a portion of the photo depicting Jill throwing a bowling ball. The thumbs up sticker may be overlaid onto the photo of the fundraising social network post to create an overlaid fundraising social network post. In an example, a modify command, such as a resize command, may be received, and the thumbs up sticker may be resized, rotated, flipped, or otherwise modified based upon the modify command. In another example, a reposition command may be received, and the thumbs up sticker may be repositioned within the overlaid fundraising social network post, such as near a portion of the photo depicting the child holding a bowling ball. In another example, a tag command may be received, and the thumbs up sticker may be tagged with a tag of a social network user specified by the tag command (e.g., Jack may tag Dan in the thumbs up sticker). In another example, a share command may be received, and the overlaid fundraising social network post may be sent to a second user specified by the share command (e.g., sent through email, text message, a social network post, etc.). In another example, a create file command may be received, and a file depicting the overlaid fundraising social network post may be generated.

The overlaid fundraising social network post may be displayed to other users, such as a second user through a social network newsfeed of the second user. Responsive to receiving user interaction with the content from the second user (e.g., the second user may select the thumbs up sticker), various information about the content may be displayed, such as a textual description for the content, a timestamp of when the content as overlaid the social network post, a user identification of the commentator user (e.g., a social network username, an email address, etc.), etc. In an example where a thought bubble was overlaid the fundraising social network post to create the overlaid fundraising social network post, text of the thought bubble may be initially hidden until the second user interacts with the thought bubble (e.g., the text may be displayed based upon a cursor hovering over the thought bubble). Responsive to receiving a content filter command from the second user, one or more content, overlaid the overlaid fundraising social network post, may be visually hidden (e.g., the second user may filter all overlaid content, content overlaid by a particular commentating user, selected overlaid content, a type of overlaid content such as links, etc.). In an example, the second user may overlay content onto the overlaid fundraising social network post. For example, second user input, at a second position within the overlaid fundraising social network post, may be received from the second user. The second user input may correspond to a second content overlay command associated with second content. For example, the second user may upload an image of the second user and a second child bowling at last year's fundraising event. The second user may position the image over a bottom right corner of the overlaid fundraising social network post. In this way, the second content, such as the image, may be overlaid onto the overlaid fundraising social network post at the second position to create an updated overlaid fundraising social network post, which may be shared with other users.

In an example, the overlaid fundraising social network post may be displayed to the originating user that created the fundraising social network post. Responsive to receiving a response command from the originating user, response content, of the response command, may be overlaid onto the content of the overlaid fundraising social network post to create an updated overlaid fundraising social network post. For example, Jill may overlay a comment “Fun Times”, as response content to the thumbs up sticker, onto the overlaid fundraising social network post. In another example, the original user may provide a remove command used to remove the content, such as the thumbs up sticker, from the overlaid fundraising social network post. In this way, users may visually and positionally overlay content onto social network posts. At 410, the method 400 ends.

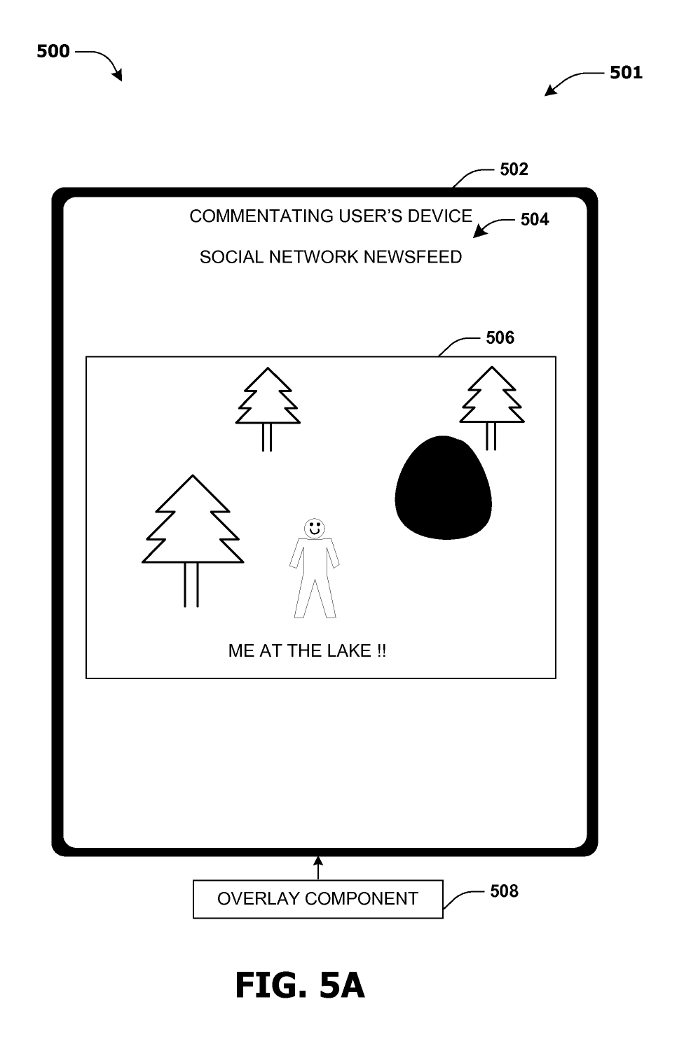

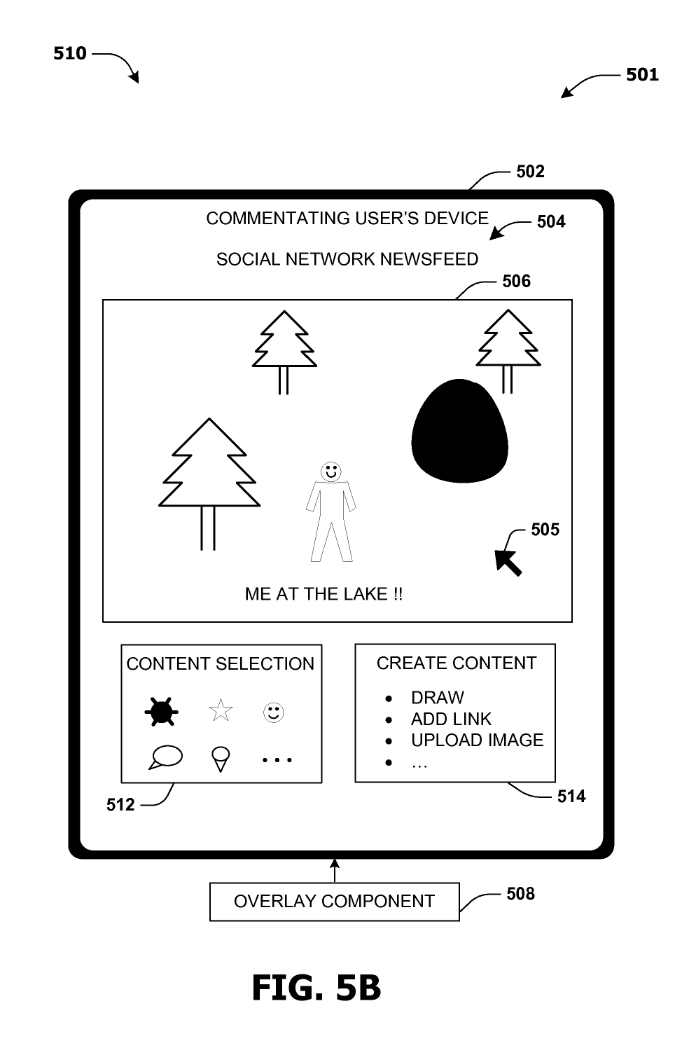

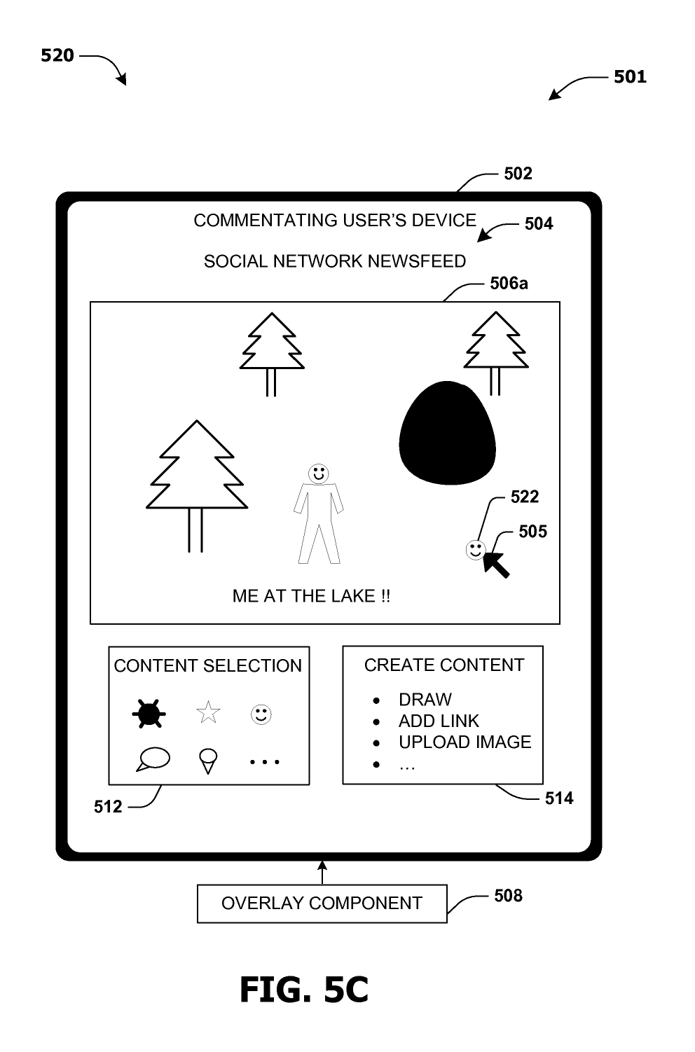

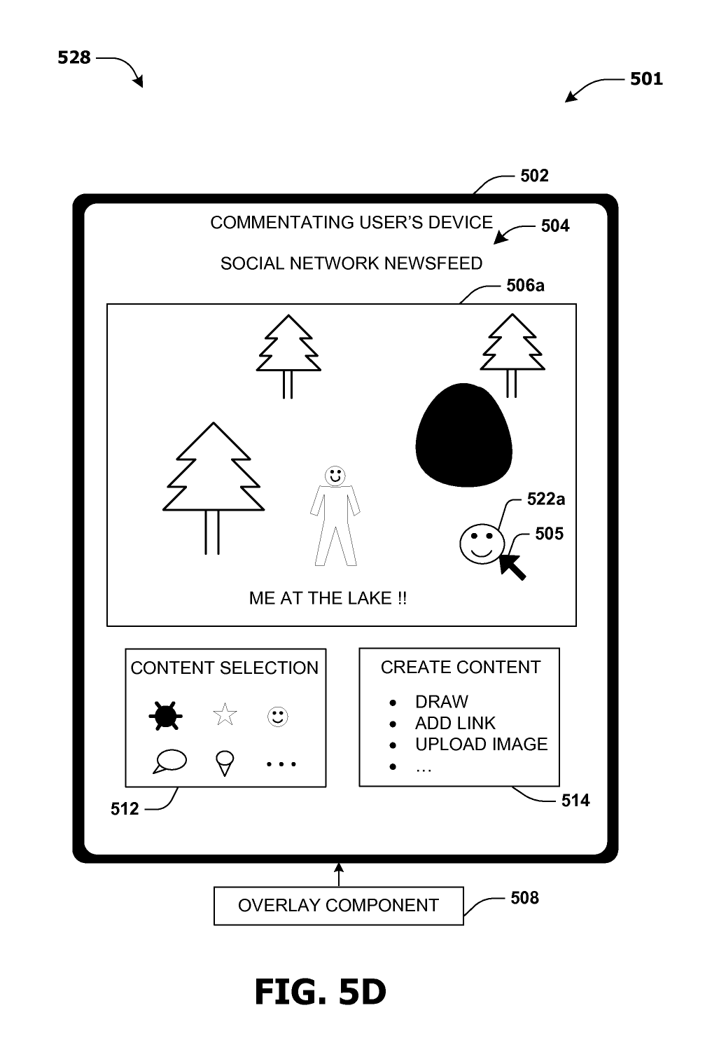

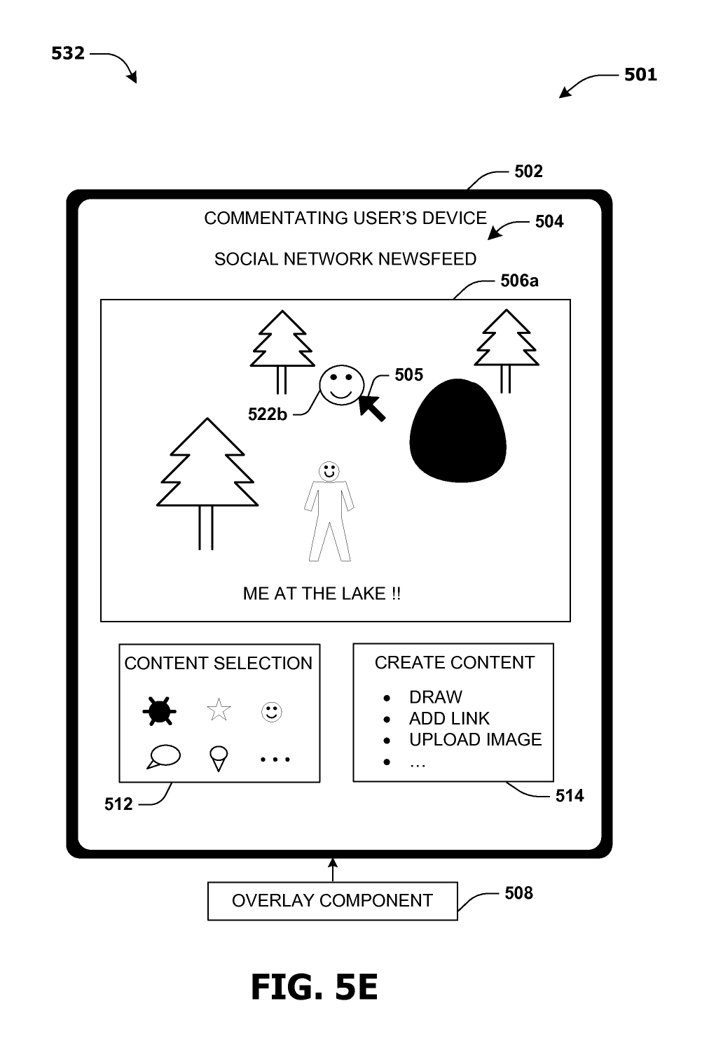

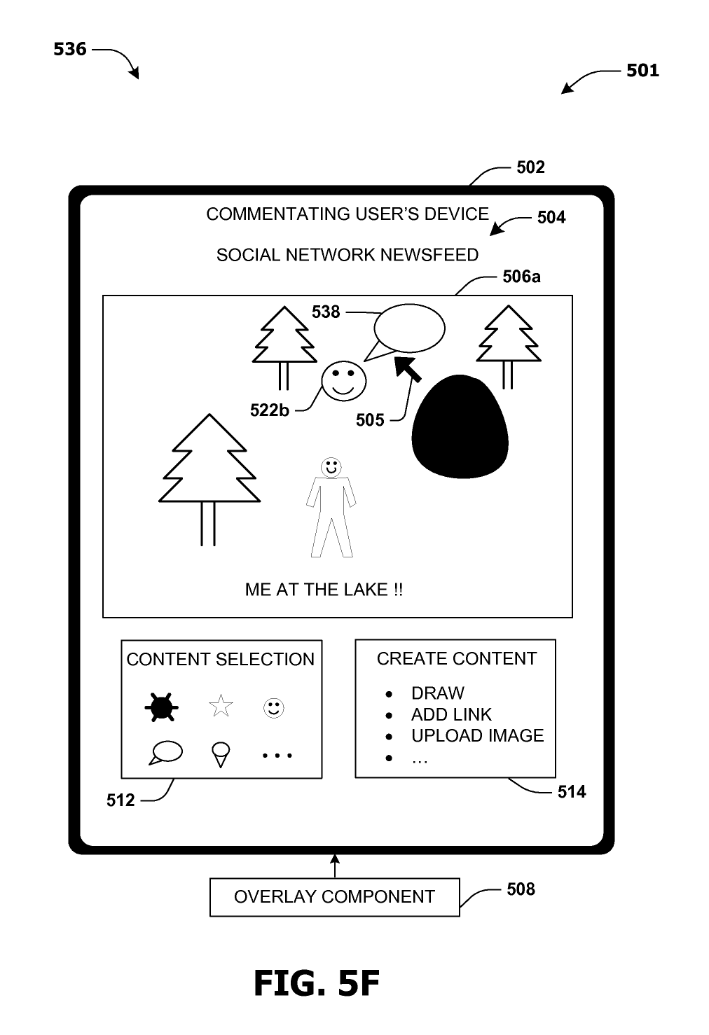

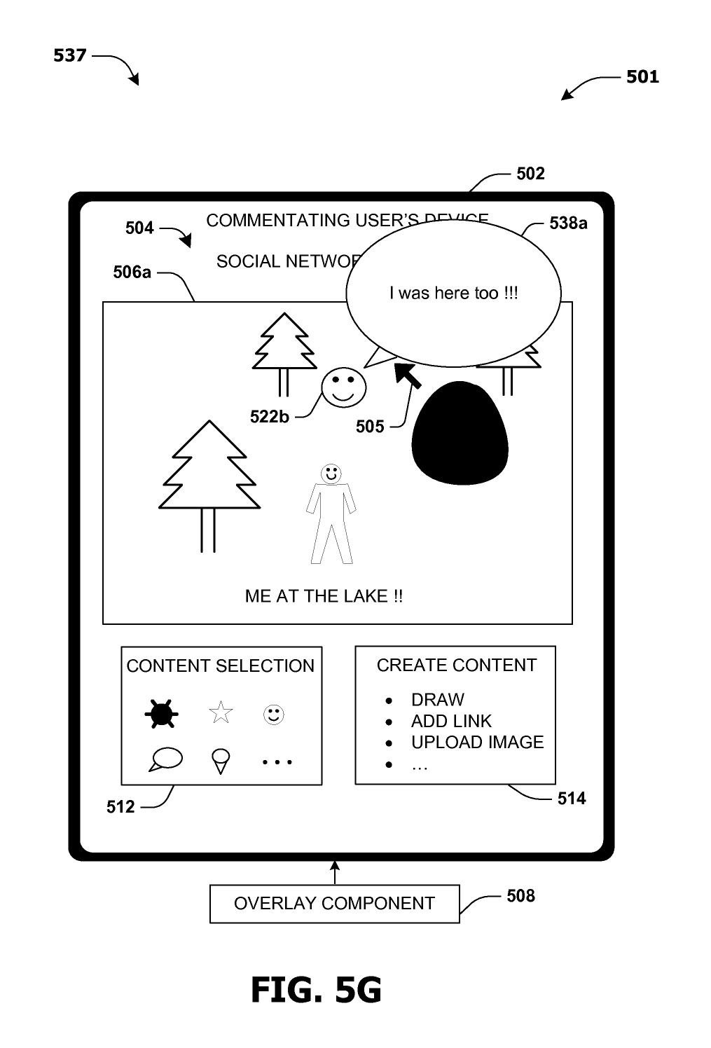

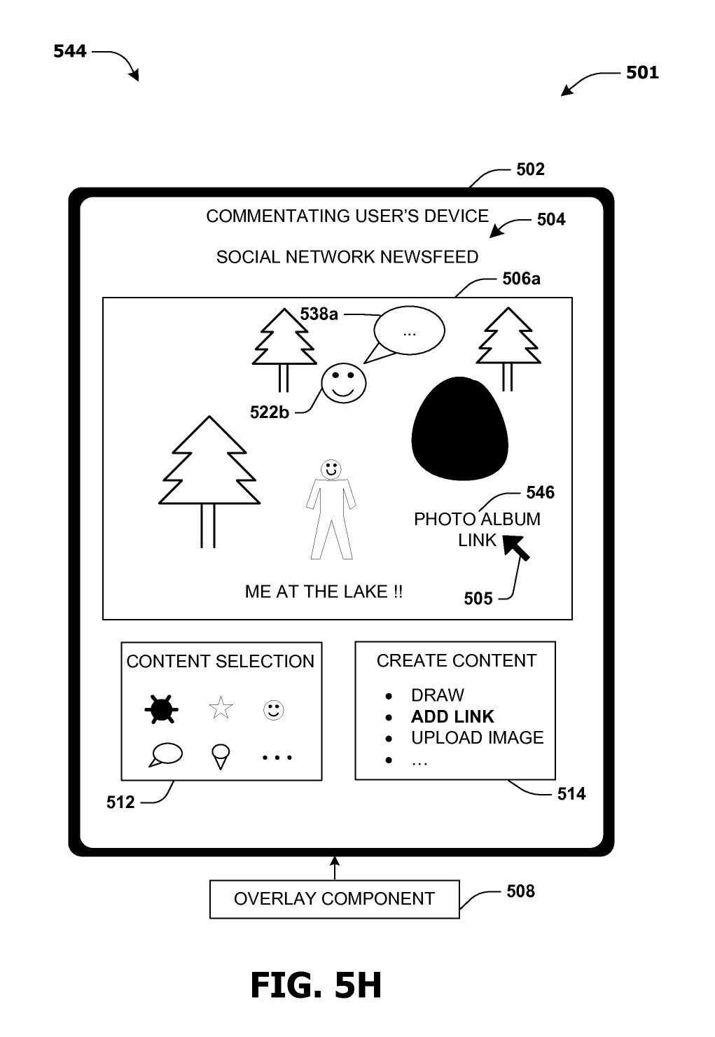

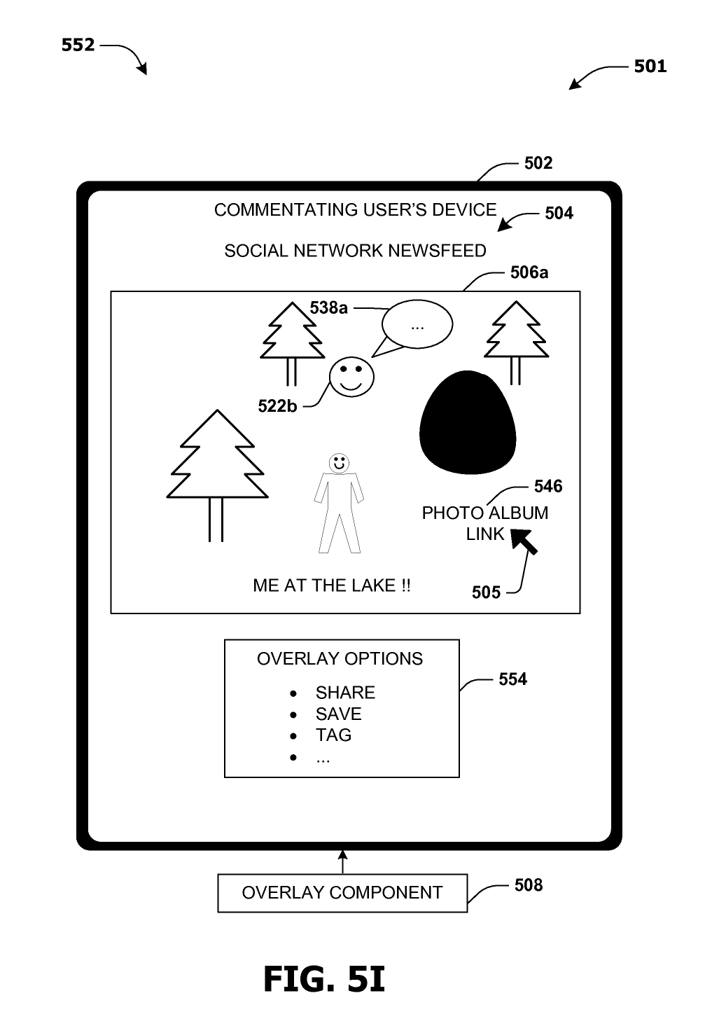

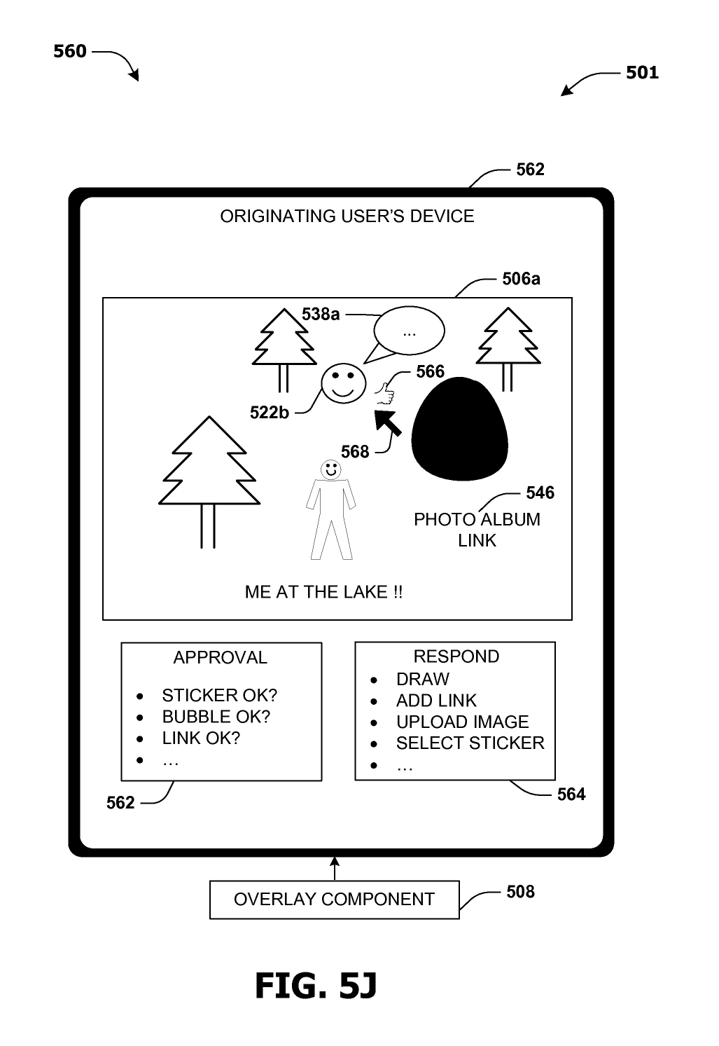

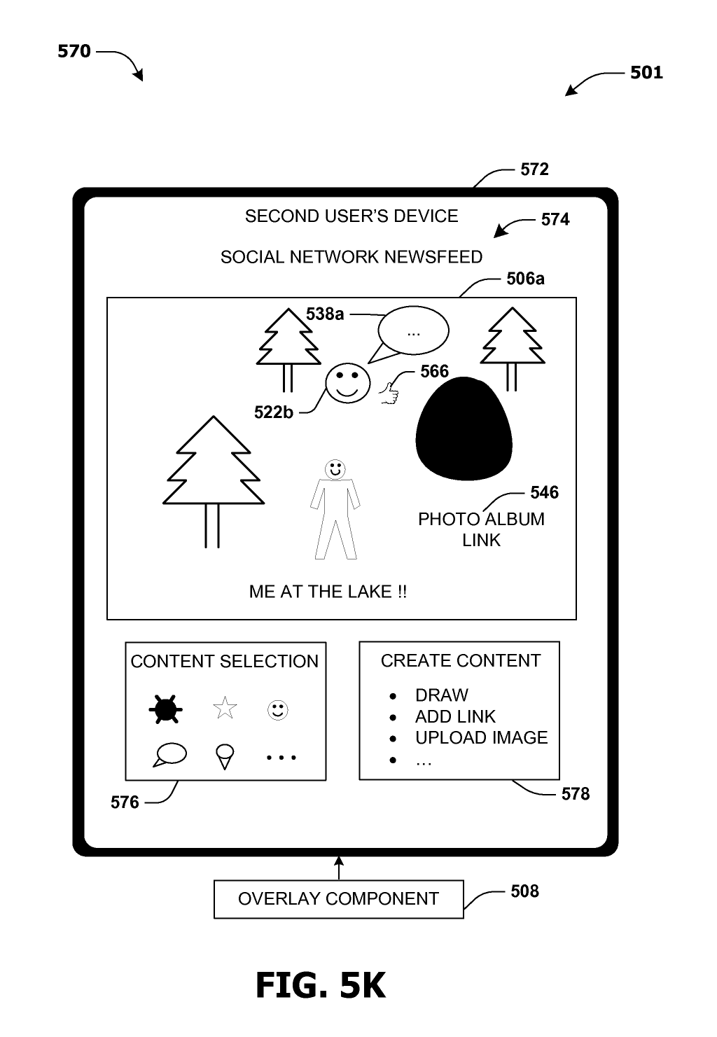

FIGS. 5A-5K illustrate examples of a system 501, comprising an overlay component 508, for overlaying content items onto social network posts. FIG. 5A illustrates an example 500 of a social network newsfeed 504 being displayed to a commentating user through a commentating user's device 502. The social network newsfeed 504 may be populated with a social network post 506 comprising a lake photo and text “me at the lake !!”. FIG. 5B illustrates an example 510 of the overlay component 508 exposing a content selection interface 512 and a create content interface 514 that the commentating user may interface with using a cursor 505. For example, the content selection interface 512 may be populated with available content for selection by the commentating user, such as a sun sticker, a star sticker, a smiley face sticker, a thought bubble, an ice cream cone sticker, images, phrases, links to external content (e.g., a link to a boating website identified as corresponding to a topic of the social network post 506, which may be determined based upon image and/or textual recognition techniques), etc. The create content interface 514 may provide options for the commentating user to draw on top of the social network post 506, add a link on top of the social network post 506, upload an image to overlay on top of the social network post 506, and/or create other content for overlaying the social network post 506.

FIG. 5C illustrates an example 520 of the commentating user dragging and dropping the smiley face sticker from the content selection interface 512 onto a first position of the cursor 505 within the social network post 506 as an overlaid smiley face sticker 522 that is overlaid onto the social network post 506. In this way, an overlaid social network post 506a, comprising the overlaid smiley face sticker 522 overlaid the lake photo, may be created. FIG. 5D illustrates an example 528 of the overlay component 508 receiving a resize command from the commentating user (e.g., the commentating user may select a resize command option or may drag a selection boundary of the smiley face sticker 522). Accordingly, the overlay component 508 may adjust a size of the smiley face sticker 522 based upon the resize command, thus resulting in a resized smiley face sticker 522a. FIG. 5E illustrates an example 532 of the overlay component 508 receiving a reposition command from the commentating user (e.g., the commentating user may drag the resized smiley face sticker 522a from the first position to a second position within the overlaid social network post 506a). Accordingly, the overlay component 508 may adjust a position of the resized smiley face sticker 522a based upon the reposition command, thus resulting in a repositioned smiley face sticker 522b at the second position within the overlaid social network post 506a.

FIG. 5F illustrates an example 536 of the commentating user dragging and dropping the thought bubble from the content selection interface 512 onto a position of the cursor 505 within the overlaid social network post 506a as an overlaid thought bubble 538 that is overlaid onto the overlaid social network post 506a. FIG. 5G illustrates an example 537 of the commentating user providing text “I was here too !!!” through a text entry interface for population within the overlaid thought bubble 538 to create a populated thought bubble 538a. FIG. 5H illustrates an example 544 of the commentating user using the add link option of the create content interface 514 to overlay a link 546, to a shared photo album, onto the overlaid social network post 506a (e.g., the commentating user may select the add link option, input an address linking to the shared photo album, and may position the link 546 onto the overlaid social network post 506a). FIG. 51 illustrates an example 552 of the overlay component 508 expose overlay options 554 to the commentating user. For example, the commentating user may share the overlaid social network post 506a with a second user, such as through email, a message, or a social network post. The commentating user may save the overlaid social network post 506a as a file, such as an image. The commentating user may tag overlaid content with a tag of a social network user.

FIG. 5J illustrates an example 560 of the overlay component 508 displaying the overlaid social network post 506a to the originating user through an originating user's device 562. The overlay component 508 may display an approval interface 562 and/or a response interface 564 to the originating user. The approval interface 562 may allow the originating user to approve or remove overlaid content within the overlaid social network post 506a, such as the repositioned smiley face sticker 522b, the populated thought bubble 538a, and the link 546 that were overlaid the overlaid social network post 506a by the commentating user. The respond interface 562 may allow the originating user to overlay response content onto the overlaid social network post 506a. For example, the originating user may select a thumbs up sticker from the respond interface 562 to overlay onto the overlaid social network post 506a as response content 566 at a position of a cursor 568.

FIG. 5K illustrates an example 570 of the overlay component 508 displaying the overlaid social network post 506a to a second user. For example, the overlay component 508 may populate a social network newsfeed 574, displayed through a second user's device 572 of the second user, with the overlaid social network post 506a. The second user may provide content, such as selected content through a content selection interface 576 and/or content created through the create content interface 578, for overlaying onto the overlaid social network post 506a to create an updated overlaid social network post comprising overlaid content by multiple users. In an example, the second user may filter overlaid content of the overlaid social network post 506a based upon types of content, content overlaid by particular users, hiding all overlaid content, etc.

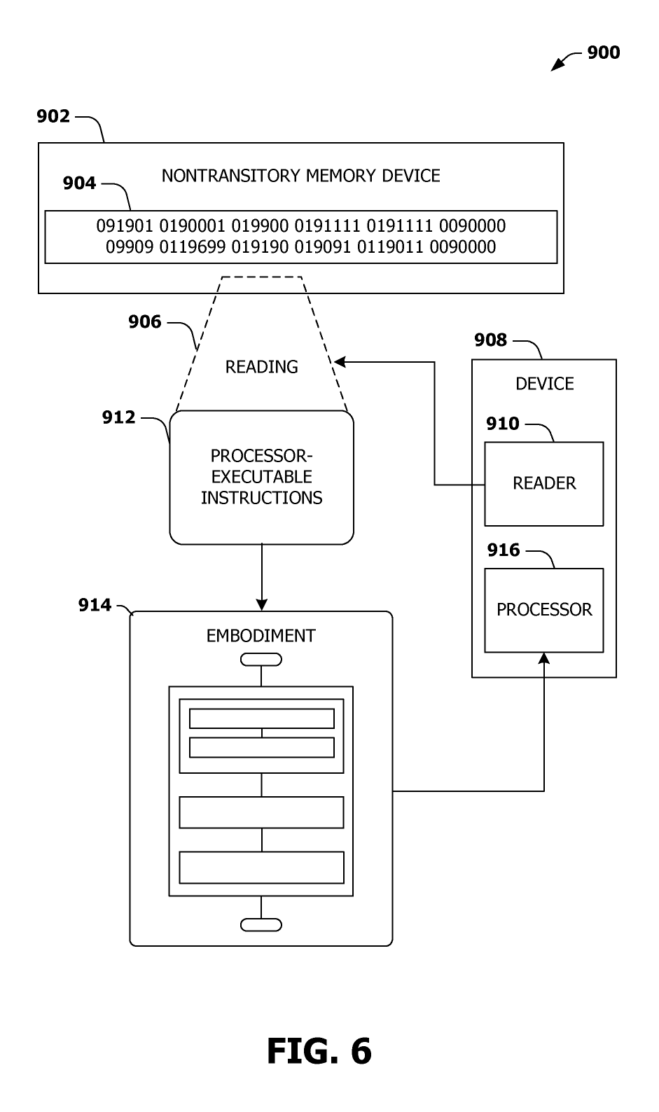

FIG. 6 is an illustration of a scenario 600 involving an example nontransitory memory device 602. The nontransitory memory device 602 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 602 stores computer-readable data 604 that, when subjected to reading 606 by a reader 610 of a device 608 (e.g., a read head of a hard disk drive, or a read operation invoked on a solid-state storage device), express processor-executable instructions 612. In some embodiments, the processor-executable instructions, when executed on a processor 616 of the device 608, are configured to perform a method, such as at least some of the example method 400 of FIG. 4, for example. In some embodiments, the processor-executable instructions, when executed on the processor 616 of the device 608, are configured to implement a system, such as at least some of the example system 501 of FIGS. 5A-5K, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for overlaying content items onto social network posts, comprising:
displaying a social network post, created by an originating user, to a commentating user;
receiving user input, from the commentating user, at a position within the social network post, the user input corresponding to a content overlay command associated with content; and
overlaying the content onto the social network post at the position to create an overlaid social network post.

2. The method of claim 1, the content comprising at least one of an image, text, a shape, a sticker, an animation, a user interface element, or a thought bubble.

3. The method of claim 1, the content comprising a link to at least one of a website, audio content, a video, execution of an application, a coupon, a location within a map interface, a document, or task completion functionality.

4. The method of claim 1, comprising:
exposing a create content interface to the commentating user; and
receiving user generated content, based upon user interaction with the create content interface, as the content.

5. The method of claim 1, comprising:
exposing a content selection interface, populated with a plurality of available content, to the commentating user; and
receiving a selection, based upon user interaction with the create content interface, of available content as the content.

6. The method of claim 1, the overlaying comprising:
responsive to receiving a reposition command, moving the content from the position to a new position within the overlaid social network post.

7. The method of claim 1, comprising:
displaying the overlaid social network post to a second user.

8. The method of claim 7, comprising:
receiving second user input, from the second user, at a second position within the overlaid social network post, the second user input corresponding to a second content overlay command associated with second content; and
overlaying the second content onto the overlaid social network post at the second position to create an updated overlaid social network post.

9. The method of claim 7, comprising:
responsive to receiving a content filter command from the second user, hiding one or more content overlaid the overlaid social network post based upon the content filter command.

10. The method of claim 1, comprising:
responsive to receiving a resize command, adjusting a size of the content within the overlaid social network post.

11. The method of claim 1, the content comprising a thought bubble, and the method comprising:
displaying a text entry interface to the commentating user; and
responsive to receiving text through the text entry interface, populating the thought bubble with the text.

12. The method of claim 10, comprising:
displaying the overlaid social network post to a second user where the text of the thought bubble is hidden; and
responsive to user interaction with the thought bubble, displaying the text.

13. The method of claim 1, comprising:
responsive to receiving a tag command for the content within the overlaid social network post, tagging the content with a tag of a social network user specified by the tag command.

14. The method of claim 7, comprising:
responsive to user interaction with the content, displaying at least one of a textual description for the content, a timestamp of the content, or a user identification of the commentator user.

15. The method of claim 1, comprising:
displaying the overlaid social network post to the originating user; and
responsive to receiving a response command from the originating user, overlaying response content, of the response command, onto the content of the overlaid social network post to create an updated overlaid social network post.

16. The method of claim 1, comprising:
displaying the overlaid social network post to the originating user; and
responsive to receiving a remove command from the originating user, removing the content from the overlaid social network post.

17. The method of claim 1, comprising:
responsive to receiving a share command associated with the overlaid social network post, sending the overlaid social network post to a second user based upon the share command.

18. The method of claim 1, comprising:
responsive to receiving a create file command associated with the overlaid social network post, generating a file depicting the overlaid social network post.

19. A system for overlaying content items onto social network posts, comprising:
an overlay component configured to:
display a social network post, created by an originating user, to a commentating user;
receive user input, from the commentating user, at a position within the social network post, the user input corresponding to a content overlay command associated with content;
overlay the content onto the social network post at the position to create an overlaid social network post; and
display the overlaid social network post to a second user.

20. A non-transitory computer readable medium comprising computer executable instructions that when executed by a processor perform a method for overlaying content items onto social network posts, comprising:
displaying a social network post, created by an originating user, to a commentating user;
receiving user input, from the commentating user, at a position within the social network post, the user input corresponding to a content overlay command associated with content, the receiving user input comprising:
exposing a create content interface to the commentating user; and
receiving at least one of user markup, user uploaded content, user specified text, or user generated content, through the create content interface, as the content; and
overlaying the content onto the social network post at the position to create an overlaid social network post.
